(19) United States
(12) Patent Application Publication
(10) Pub. No.: US 2013/0174487 A1
(43) Pub. Date: Jul. 11, 2013

(54) LOCKLESS METAL FIREPROOF DOOR

(71) Applicant: Che-An Tsai, Kaohsiung City (TW)

(72) Inventor: Che-An Tsai, Kaohsiung City (TW)

(21) Appl. No.: 13/591,905

(22) Filed: Aug. 22, 2012

(30) Foreign Application Priority Data
Jan. 6, 2012 (TW) 101200319

(51) Int. Cl. E06B 5/16; E05F 15/20

(52) U.S. Cl. 49/7; 49/31

(57) ABSTRACT

A lockless metal fireproof door is pivotably mounted to an outer frame and includes two metal sheets, with a fireproof mechanism mounted in each metal sheet. A hinge is mounted to a bottom of the lockless metal fireproof door for automatically returning the lockless metal fireproof door, with a gap provided between each metal sheet and the outer frame. The lockless metal fireproof door can be moved to a position and retained in the position by the ground hinge. The lockless metal fireproof door is positioned by a weight thereof after the lockless metal fireproof door reaches the position. The lockless metal fireproof door expands in a lateral direction to tightly press against the outer frame if a side of the lockless metal fireproof door is subjected to heat.

### BACKGROUND OF THE INVENTION

The present invention relates to a lockless metal fireproof door and, more particularly, to a metal fireproof door that provides a fireproof effect without using a lock while providing a sense of quality for the structure to which the fireproof door is mounted.

Fireproof doors are mounted in public passages and include single-door type and double-door type and can be opened by pivoting 90°, 180°, 270°, or 360°. The fireproof doors are either normally open or normally closed according to needs. A side of a fireproof must be below a preset temperature while the other side of the fireproof door is subjected to heat. Furthermore, the fireproof doors must meet the standards of deformation and impact resistance to reliably isolate the frames when a fire occurs.

A fireproof door generally includes two metal sheets in which a fireproof frame or various fireproof materials are mounted. A lock is mounted to the fireproof door and engaged with an outer frame to provide limited access. However, the lock is useless in a normally open type fireproof door. Furthermore, the lock protruding out of an outer side of the fireproof door adversely affects the appearance and does not match the wall of the structure, failing to provide the structure with a sense of quality.

### BRIEF SUMMARY OF THE INVENTION

An objective of the present invention is to provide a fireproof door that provides a fireproof effect without using a lock while providing a sense of quality for the structure.

Another objective of the present invention is to provide a lockless fireproof door having smaller deformation in a central portion thereof.

A lockless metal fireproof door according to the present invention is pivotably mounted to an outer frame and includes two metal sheets, with a fireproof mechanism mounted in each metal sheet. A hinge is mounted to a bottom of the lockless metal fireproof door for automatically returning the lockless metal fireproof door, with a gap provided between each metal sheet and the outer frame. The lockless metal fireproof door can be moved to a position and retained in the position by the ground hinge. The lockless metal fireproof door is positioned by a weight thereof after the lockless metal fireproof door reaches the position. The lockless metal fireproof door expands in a lateral direction to tightly press against the outer frame if a side of the lockless metal fireproof door is subjected to heat. Thus, the lockless metal fireproof door can be reliably positioned by pressing against the outer frame and can reliably resist fire without using a lock while providing a sense of quality of structure to which the lockless metal fireproof door is mounted.

The hinge can be a ground hinge allowing automatic returning or a flag hinge or a butterfly hinge.

The lockless metal fireproof door can be normally open or normally closed.

In an example, the lockless metal fireproof door is normally open and positioned in an open position by an electromagnetic valve. Power supply to the electromagnetic valve is cut off if a fire occurs, with the lockless metal fireproof door moved to a closed position under action of the hinge. The lockless metal fireproof door can further include two stops provided on two sides thereof. When the lockless metal fireproof door is closed, the stops abut against the metal sheets to avoid frames and smoke.

In another example, the lockless metal fireproof door further includes an opening in a central portion thereof, with the opening including a recessed engaging portion having a lateral side and an engagement side. A coupling board is mounted in the opening and includes a lateral side having a protruding coupling portion. The protruding coupling portion of the coupling board includes an inner protruding face and an inner protruding coupling face. The inner protruding coupling face is fixed to the lateral side of the recessed engaging portion, with a buffering gap defined between the inner protruding face of the coupling board and the lateral side of the recessed engaging portion.

The present invention will become clearer in light of the following detailed description of illustrative embodiments of this invention described in connection with the drawings.

### DESCRIPTION OF THE DRAWINGS

FIG. 1 shows a diagrammatic top view of a lockless metal fireproof door according to the present invention.

FIG. 2 shows a view similar to FIG. 1, with the lockless metal fireproof door pressing against an outer frame during a fire.

FIG. 3 shows a front view of the lockless metal fireproof door of FIG. 2 during a fire.

FIG. 4 shows a diagrammatic top view of the lockless metal fireproof door according to the present invention mounted in a public place.

FIG. 5 shows a view similar to FIG. 4, with the lockless metal fireproof door closed.

FIG. 6 shows another example of the lockless metal fireproof door according to the present invention.

FIG. 7 shows a view similar to FIG. 6, with the lockless metal fireproof door pressing against an outer frame during a fire.

### DETAILED DESCRIPTION OF THE INVENTION

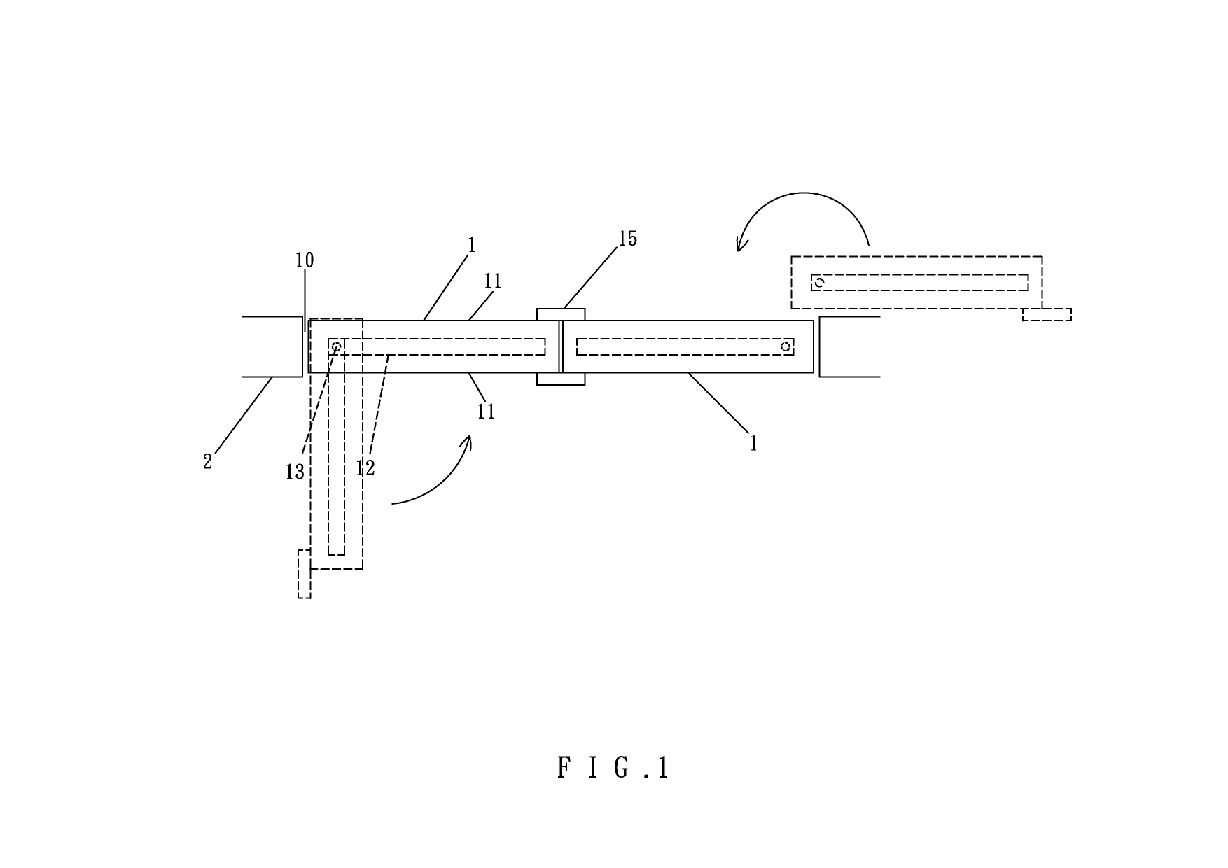

With reference to FIG. 1, a lockless metal fireproof door 1 according to the present invention is pivotably mounted to an outer frame 2 and includes two metal sheets 11 in which a fireproof mechanism 12 is mounted. A ground hinge 13 is mounted to a bottom of the lockless metal fireproof door 1 for automatically returning the lockless metal fireproof door 1 to its initial position. A gap 10 is provided between each metal sheet 11 and the outer frame 2. When a fire occurs, the gaps 10 allow deformation of the metal sheets 11 subjected to heat. Two stops 15 are provided on two sides of the lockless metal fireproof door 1. When the lockless metal fireproof door is closed, the stops 15 abut against the metal sheets 1 to avoid frames and smoke.

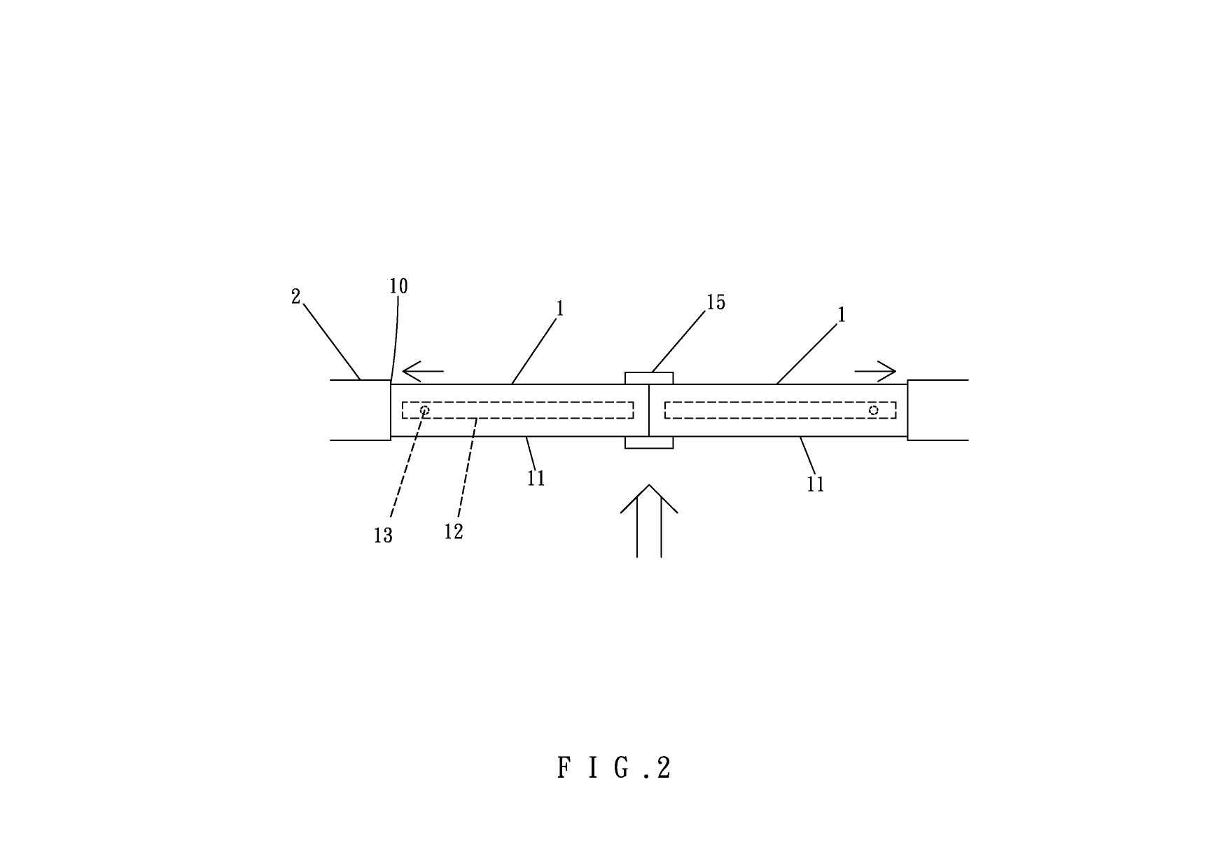

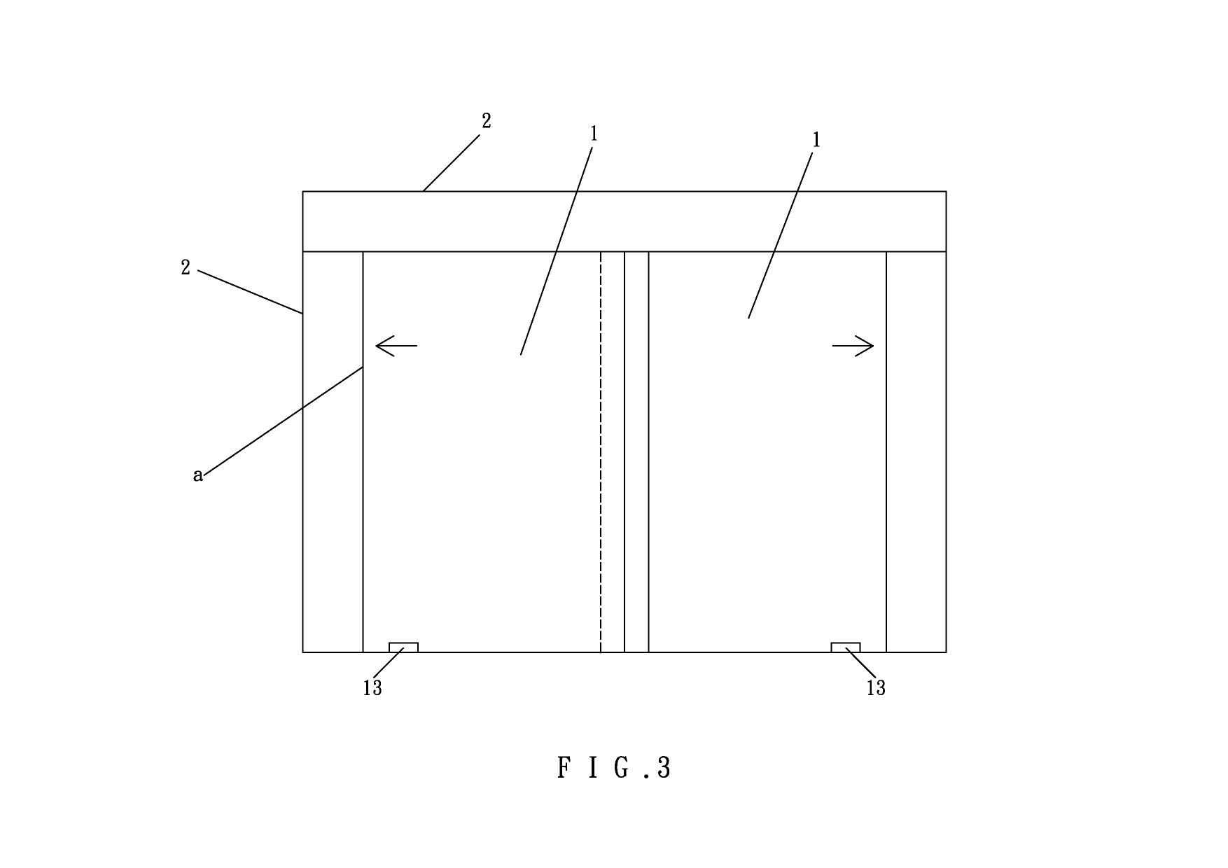

With reference to FIGS. 2 and 3, the lockless metal fireproof door 1 can be moved to a position and retained in the position by the ground hinge 13. The lockless metal fireproof door 1 is positioned by its weight after the lockless metal fireproof door 1 reaches the position. When a side of the lockless metal fireproof door 1 is subjected to heat, the lockless metal fireproof door 1 expands in a lateral direction to tightly press against the outer frame 2 at a position “a” in FIG. 3, providing a reliable positioning effect such that the lockless metal fireproof door 1 can not be forcibly pushed open during a fire. Thus, the lockless metal fireproof door 1 can provide a fireproof effect without using a lock, providing the structure with a sense of quality.

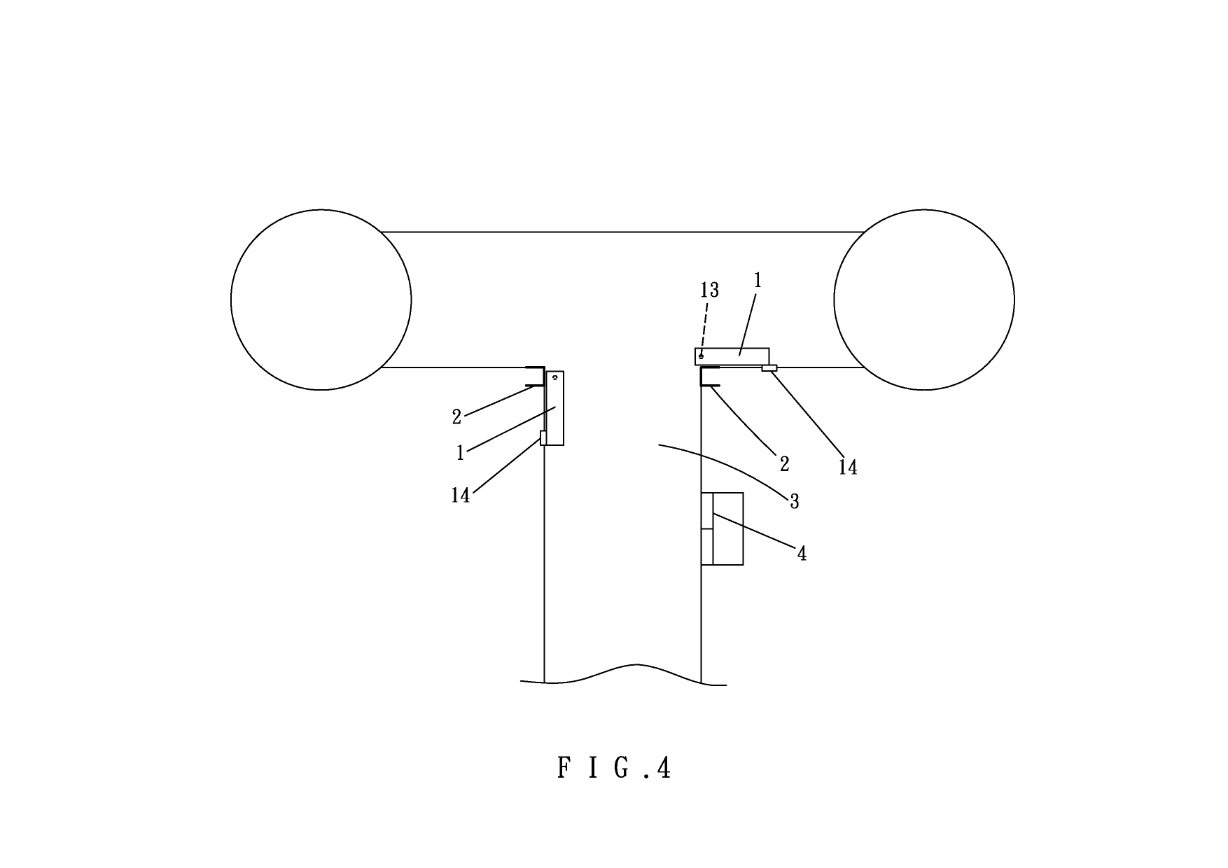

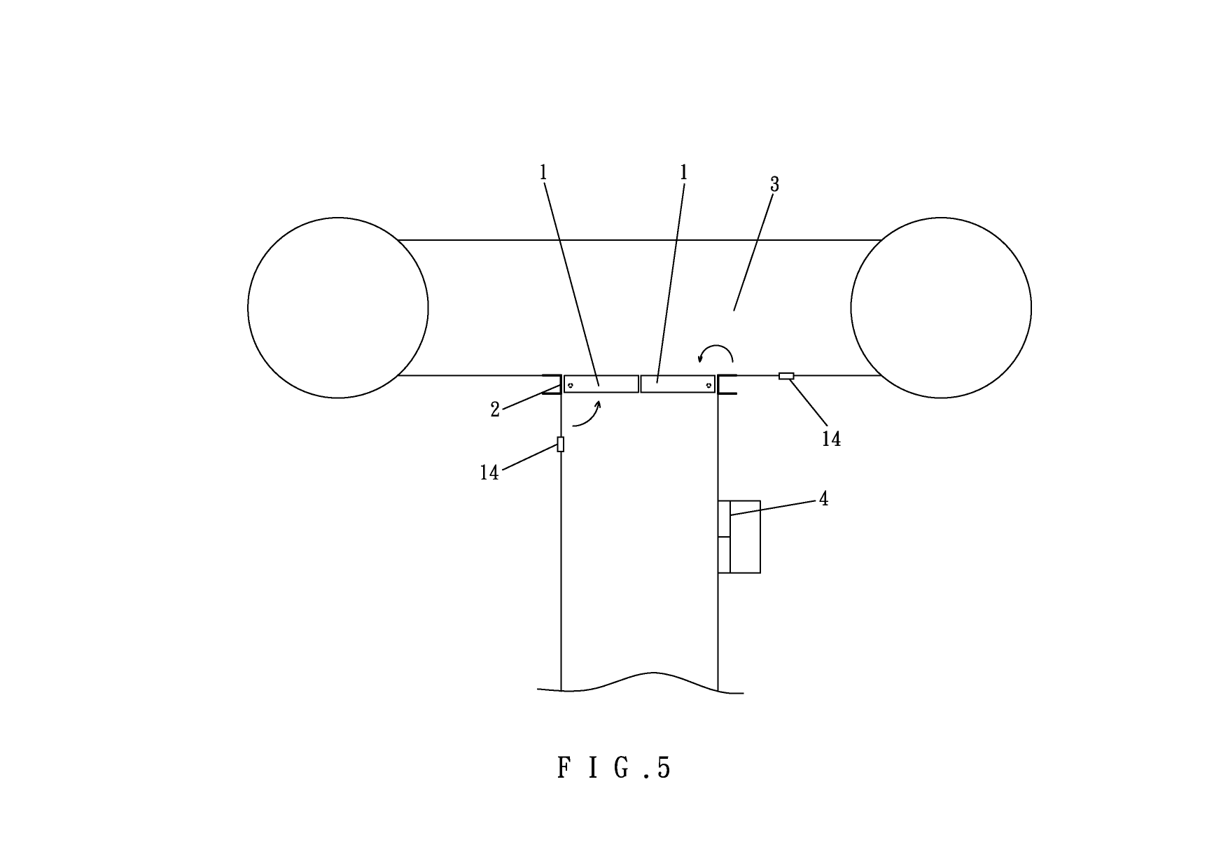

The lockless metal fireproof door 1 is normally open or normally closed. In an example shown in FIGS. 4 and 5, the lockless metal fireproof door 1 is normally open and can be positioned in the open position by electromagnetic valves 14. The lockless metal fireproof door 1 is mounted in a passage 3 having an elevator 4. In a case that a fire occurs, the power supply to the electromagnetic vales 14 is cut off such that the lockless metal fireproof door 1 automatically moves to a closed position shown in FIG. 5 under the action of the ground hinge 13. After the lockless metal fireproof door 1 has been subjected to the fire for a period of time, the lateral sides of the lockless metal fireproof door 1 expand to tightly press against the outer frame 2, providing a reliable positioning effect.

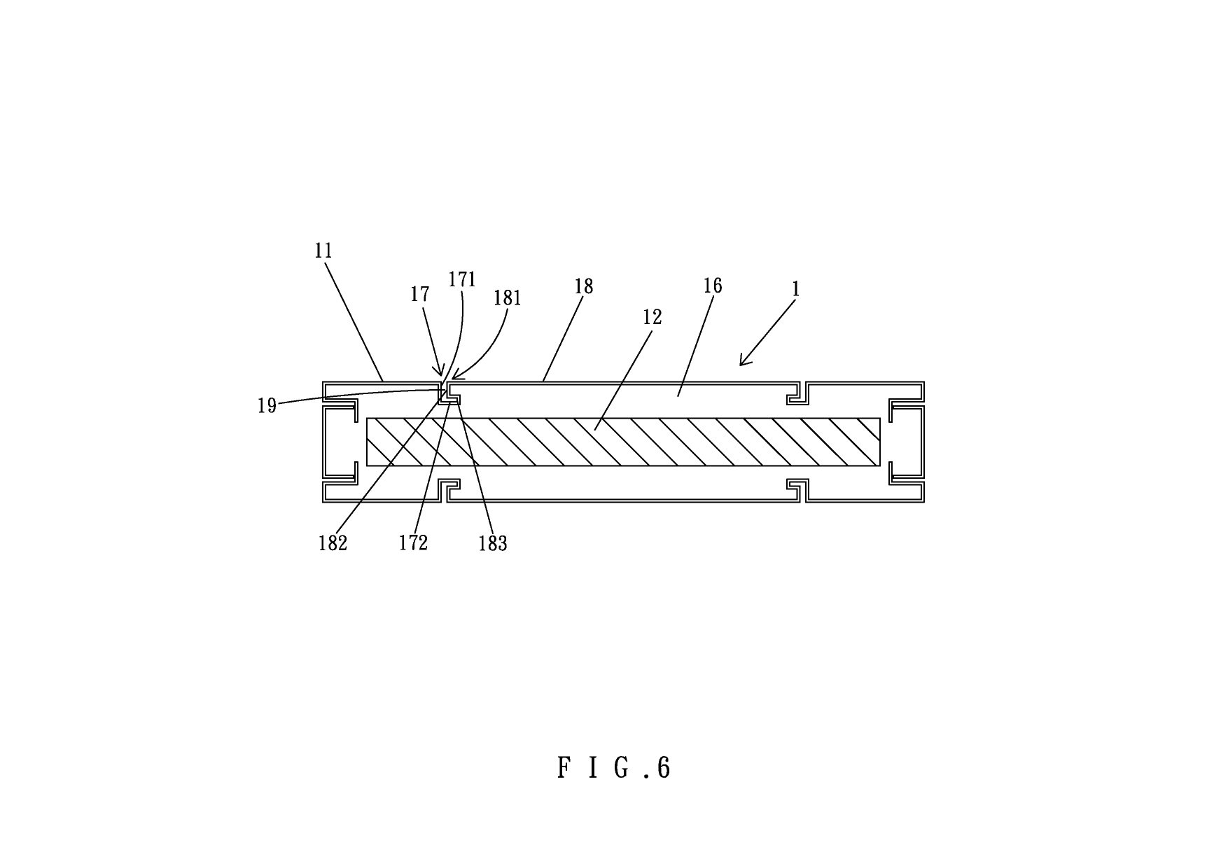

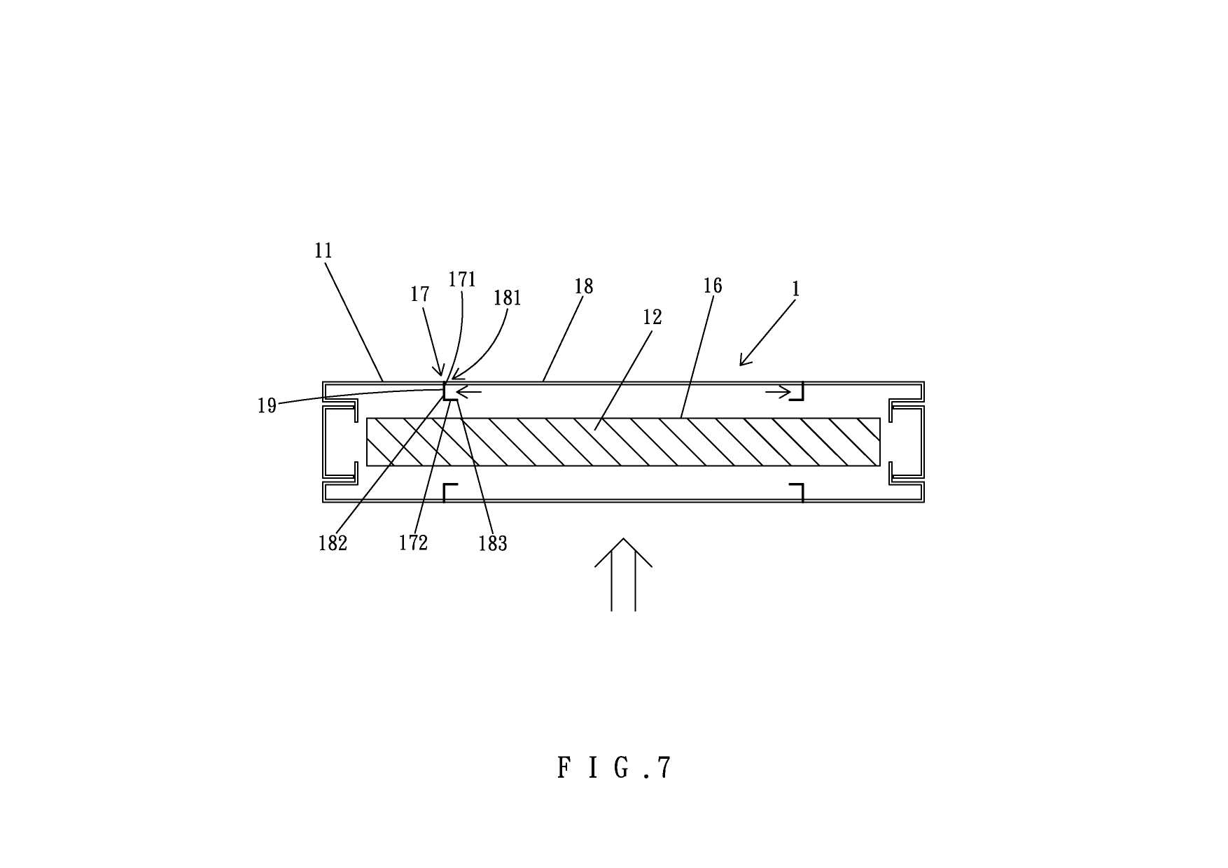

In another example shown in FIGS. 6 and 7, each metal sheet 11 of the lockless metal fireproof door 1 includes an opening 16 in a central portion thereof for mounting a coupling board 18. The opening 16 includes a recessed engaging portion 17 having a lateral side 171 and an engagement side 172. The coupling board 18 can include decorative patterns. The coupling board 18 includes a lateral side having a protruding coupling portion 181. The protruding coupling portion 181 includes an inner protruding face 182 and an inner protruding coupling face 183. The coupling board 18 is mounted in the opening 16, with the inner protruding coupling face 183 fixed to the lateral side 171 of the recessed engaging portion 17 such as by welding, with a buffering gap 19 defined between the inner protruding face 182 of the coupling board 18 and the lateral side 171 of the recessed engaging portion 17. Thus, when the lockless metal fireproof door 1 is subjected to heat and expands into the buffering gaps 19 in a direction indicated by the arrows shown in FIG. 7, the metal sheet 11 will not be squeezed, and the lockless metal fireproof door 1 can expand in the lateral direction to press against the outer frame 2. The deformation of the central portion of the lockless metal fireproof door 1 is reduced while providing a better fire resistance effect.

The lockless metal fireproof door 1 provides a sense of quality and a better fire resistance effect. The ground hinge 13 can be a flag hinge or a butterfly hinge.

Although specific embodiments have been illustrated and described, numerous modifications and variations are still possible without departing from the essence of the invention. The scope of the invention is limited by the accompanying claims.

1. A lockless metal fireproof door pivotably mounted to an outer frame, with the lockless metal fireproof door comprising two metal sheets, with a fireproof mechanism mounted in each of the two metal sheets, with a hinge mounted to a bottom of the lockless metal fireproof door for automatically returning the lockless metal fireproof door, with a gap provided between each of the two metal sheets and the outer frame, with the lockless metal fireproof door moved to a position and retained in the position by the ground hinge, with the lockless metal fireproof door positioned by a weight thereof after the lockless metal fireproof door reaches the position, with the lockless metal fireproof door expanding in a lateral direction to tightly press against the outer frame if a side of the lockless metal fireproof door is subjected to heat.

2. The lockless metal fireproof door as claimed in claim 1, with the hinge being a ground hinge allowing automatic returning or a flag hinge or a butterfly hinge.

3. The lockless metal fireproof door as claimed in claim 1, with the lockless metal fireproof door being normally open or normally closed.

4. The lockless metal fireproof door as claimed in claim 3, with the lockless metal fireproof door being normally open and positioned in an open position by an electromagnetic valve, with power supply to the electromagnetic valve being cut off if a fire occurs, with the lockless metal fireproof door moved to a closed position under action of the hinge.

5. The lockless metal fireproof door as claimed in claim 4, further comprising two stops provided on two sides of the lockless metal fireproof door.

6. The lockless metal fireproof door as claimed in claim 1, with the lockless metal fireproof door further including an opening in a central portion thereof, with the opening including a recessed engaging portion having a lateral side and an engagement side, with a coupling board mounted in the opening and including a lateral side having a protruding coupling portion, with the protruding coupling portion of the coupling board including an inner protruding face and an inner protruding coupling face, with the inner protruding coupling face fixed to the lateral side of the recessed engaging portion, with a buffering gap defined between the inner protruding face of the coupling board and the lateral side of the recessed engaging portion.
